(19) United States
(12) Patent Application Publication
(10) Pub. No.: US 2007/0126289 A1
(43) Pub. Date: Jun. 7, 2007

(54) Electronic switching device with uninterruptible voltage regulating switch

(76) Inventors: Chung-Fan Liu, Tainan City (TW); Chih-Wei Hsu, Tainan County (TW)

Correspondence Address: HARNESS, DICKEY & PIERCE, P.L.C., P.O. BOX 8910, RESTON, VA, 20195, US

(21) Appl. No.: 11/356,026

(22) Filed: Feb. 17, 2006

(30) Foreign Application Priority Data
Dec. 7, 2005 (TW) 094143242

(51) Int. Cl. H01H 35/00; H02B 1/24

(52) U.S. Cl. 307/119

(57) ABSTRACT

An electronic switching device, externally connected with an alternating current power source, includes an uninterruptible voltage regulating switch for generating an energy storage electromotive force; a signal transmitter; and a remote control module connected to an electrical device, which at least has a signal controller, a voltage detector, and a power switch. The remote control module switches the power source for the electrical device, after detecting the voltage difference due to the converting between the external power source and the energy storage electromotive force, or receiving a wireless signal transmitted by a signal transmitter, so as to turn on/off the electrical device by way of remote control or manual control. The remote control module is connected in parallel to the electrical device without limiting the power efficiency of the electrical device, capable of being completely compatible with the original circuit wiring, so as to save construction space and costs.

### CROSS-REFERENCE TO RELATED APPLICATIONS

This non-provisional application claims priority under 35 U.S.C. § 119(a) on Patent Application No. 094143242 filed in Taiwan, R.O.C. on Dec. 07, 2005, the entire contents of which are hereby incorporated by reference.

### BACKGROUND OF THE INVENTION

1. Field of Invention

The present invention relates to a switch for an electrical device,. and more particularly, to an electronic switching device for an electrical device, which can be operated both by remote control and manual control.

2. Related Art

Nowadays, common remote control switches for electrical devices are generally classified into parallel-type remote control devices and series-type remote control devices.

A parallel-type remote control device is connected to an electrical device as shown in FIG. 1. A parallel-type remote control device 110 is externally connected to an alternating current (AC) power source 105, wherein the control module 102 is connected to a power switch 103 and connected to an electrical device 104 in parallel, and additionally connected to a power switch 103 to determine the action of the control module 102. The user transmits a wireless signal 107 to the control module 102 through a signal transmitter 106, and the control module. 102 makes a power-switch module 101 be open or short through a control circuit 108 when receiving the wireless signal 107, thus turning on/off an electrical device 104. However, connecting the control module 102 to the power switch 103 requires additional wiring, which will increase the cost and the construction difficulty.

A series-type remote control device is connected to an electrical device as shown in FIG. 2. A series-type remote control device 210 forms a connection loop with an electrical device 204 and an AC power source 205 through non-polar serial connection. The user transmits a wireless signal 207 to a control module 202 through a signal transmitter 206, and the control module 202 activates a power switch module 201 through a control circuit 208 when receiving the wireless signal 207, thus turning on/off the electrical device 204. However, without additional wiring, the series-type remote control device 210 must be designed to integrate with a power switch 203, for actuating the control module 202. When the power switch 203 is open, the control module 202 cannot be actuated and thus cannot receive the wireless signal 207 sent by the signal transmitter 206. Furthermore, as the connection loop is formed through non-polar serial connection, the resistances of the electrical device 204 and the series-type remote control device 210 will affect the voltage distribution. If the resistance of the electrical device 204 is excessively high, resulting in insufficient driving voltage for the series-type remote control device 210, the series-type remote control device 210 cannot be appropriately driven. In other words, if the series-type remote control device 210 has an excessively high resistance, the power of equipped electrical device 204 will be greatly restrained.

### SUMMARY OF THE INVENTION

In view of the above, an object of the present invention is to provide an electronic switching device for turning on/off an electrical device through remote control or manual control.

Based on the above object, the present invention provides an electronic switching device using an uninterruptible voltage regulating switch, externally connected to an AC power source, with a structure including:
an uninterruptible voltage regulating switch having a spring switch with a button, wherein the spring switch is an open circuit when the button is pressed and hold, being a short circuit otherwise; an energy storage element, connected in parallel to the spring switch; a remote control module, connected to an electrical device, and connected to the uninterruptible voltage regulating switch and an AC power source in series so as to form a loop integrally and to connect with an electrical device, wherein the remote control module having at least a power switch module, a signal controller, a voltage detector, and a voltage stabilizer; and a signal transmitter, which can send a wireless control signal.

In the above structure, the power switch module can be designed to be a silicon-controlled rectifier (SCR), a TRAIC, or a RELAY, and the energy storage element. can be a capacitor.

When the user presses and holds the button of the spring switch, a current will flow towards another branch circuit with an energy storage element due to the open circuit of the spring switch, and an energy storage electromotive force, which has a voltage lower than that of the externally-connected AC power source, is generated at both ends of the energy storage element. After the user releases the button of the spring switch, the spring switch will return to be a short circuit, with the power being continuously supplied to the remote control module from the AC power source. At this time, the voltage detector will detect the change of the voltage due to the converting between the AC power source and energy storage electromotive force, and send a signal to the signal controller, which will controls the open/short of the power switch module through a control circuit, so as to turn on/off the electrical device.

In addition, a wireless signal can be transmitted to the signal controller through a signal transmitter, which also controls the action of the power switch module through a control circuit after receiving the signal.

Furthermore, the remote control module won't be powered off simply by pressing down the uninterruptible voltage regulating switch, but the user can still control the on/off of the electrical device with the signal transmitter.

Therefore, the user can turn on/off the electrical device either by remote control or by manual control. Also, the electronic switch device can be configured in accordance with the wiring condition of the circuit, so there is no additional cost or wiring space required.

To make the above objects, features, and advantages of the present invention more apparent and comprehensible, a preferred embodiment will be described in details below with reference to the accompanying drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a structure diagram of a conventional parallel-type remote control switching device;

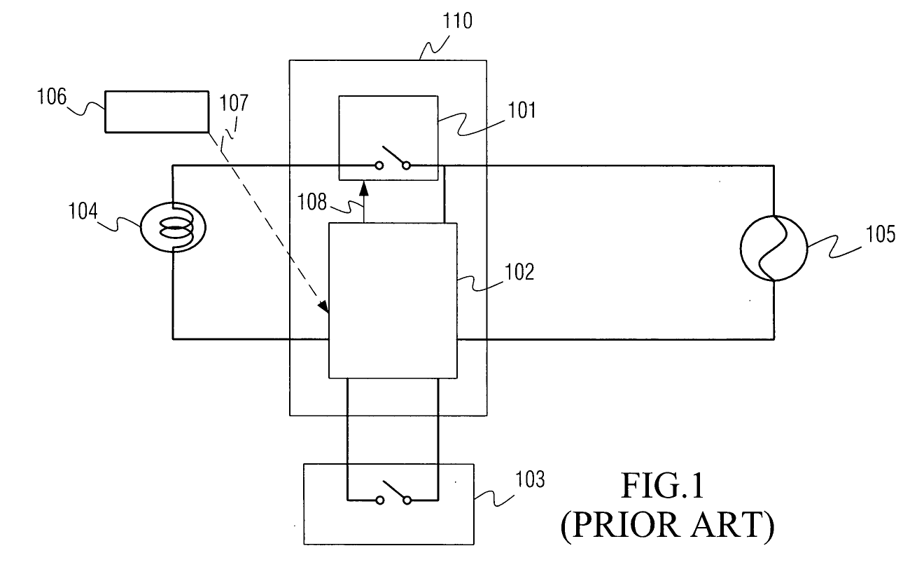

FIG. 2 is a structure diagram of a conventional series-type remote control switching device;

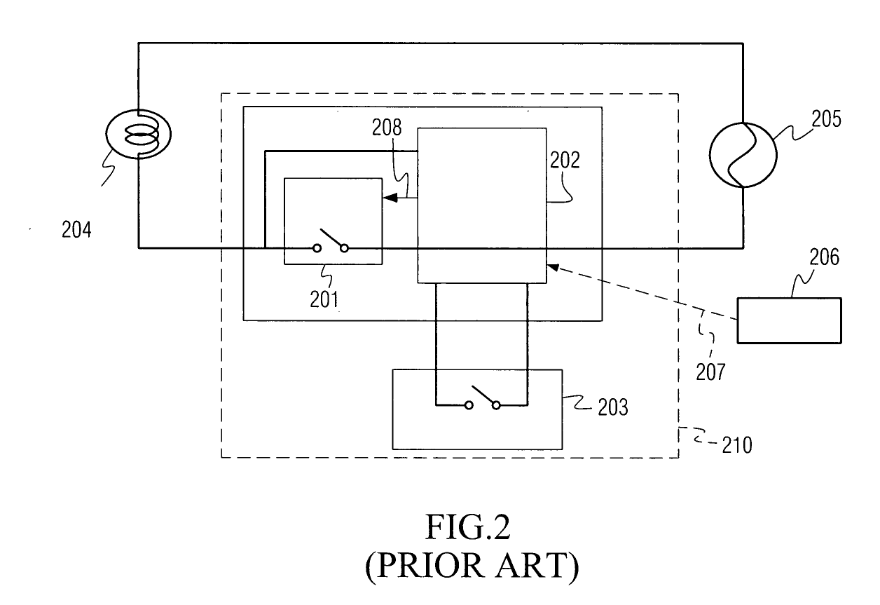

FIG. 3 is a structure diagram of an electronic switching device of the present invention;

FIG. 4 is a schematic view of the current circuit when a switching device the present invention is an open circuit;

FIG. 5 is a schematic view of the current circuit when a switching device of the present invention is a short circuit;

FIG. 6 is a schematic view of the change of a power switch module of the present invention; and

FIG. 7 is a schematic view of the switching device being controlled in the remote manner.

### DETAILED DESCRIPTION OF THE INVENTION

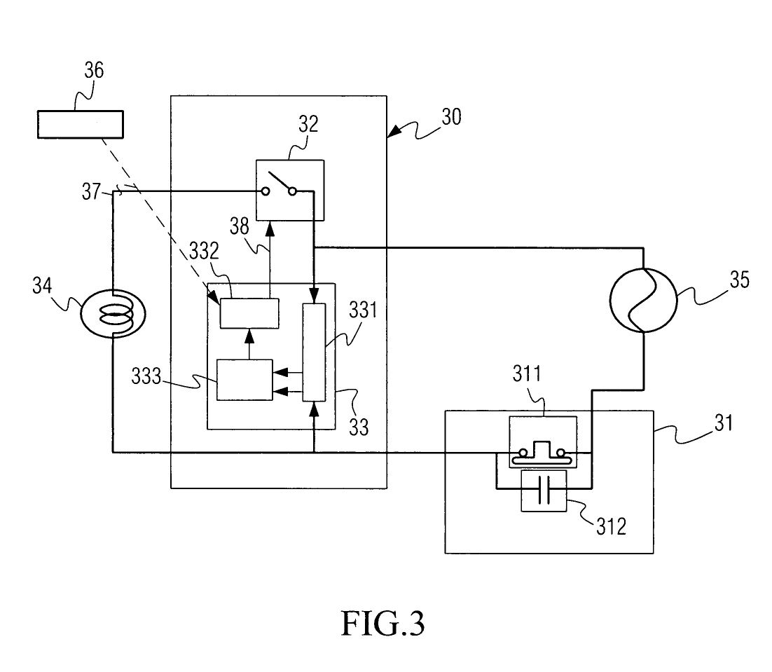

FIG. 3 is a structure diagram of an electronic switching device of a preferred embodiment of the present invention being connected to an electrical device. A remote control module 30, connected to an electrical device 34, includes a power switch module 32; a control module 33 with a signal controller 332, a voltage detector 333, and a voltage stabilizer 331, wherein the voltage stabilizer 331 is used for stabilizing the input voltage of an externally connected AC power source 35; a signal transmitter 36 capable of sending a wireless signal 37.

And, an uninterruptible voltage regulating switch 31 is externally connected to an AC power source 35, and connected to a remote control module 30 to form a series loop. The uninterruptible voltage regulating switch 31 has a spring switch 311 and is connected to an energy storage element 312 in parallel.

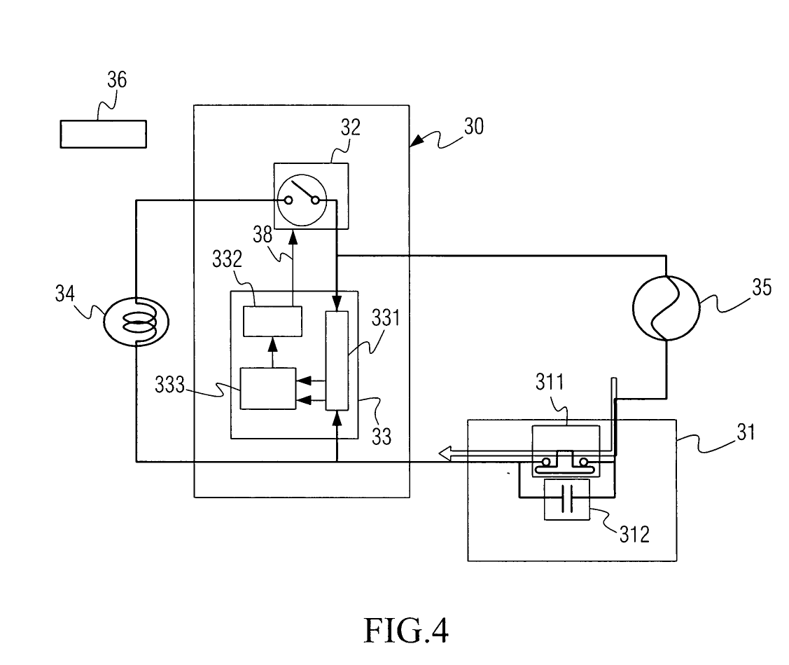

As shown in FIG. 4, a power switch module 32 is preset to be in an open circuit state, i.e., the electrical device 34 is in a closed de-energized state. Since the button of the spring switch 311 is not pressed by the user, the spring switch 311 is still in a short circuit state, and at this time, the voltage value detected by the voltage detector 333 is just the voltage value of the AC power source 35.

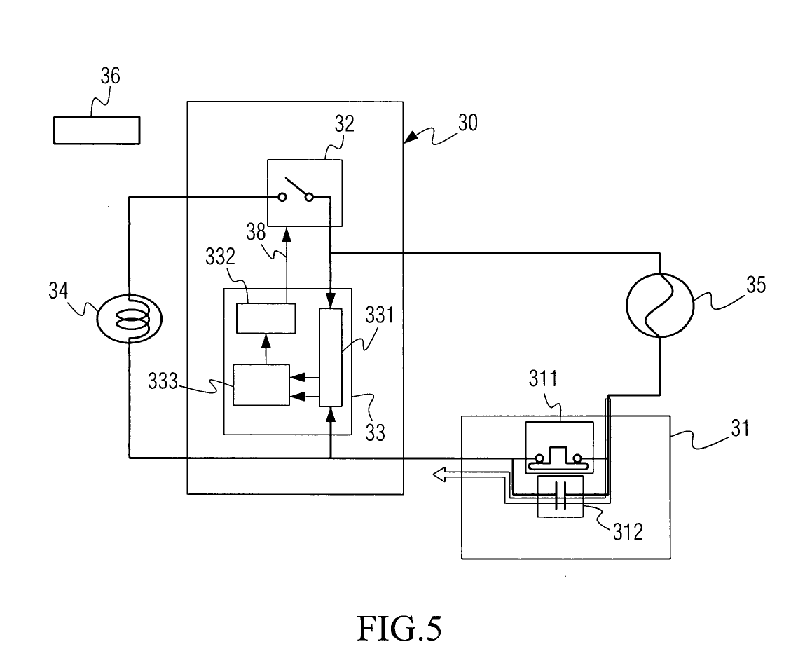

As shown in FIG. 5, when the button of the spring switch 311 is pressed by the user, the spring switch 311 will be in an open circuit state while the button is pressed and hold, such that the current flows through the branch circuit with the energy storage element 312, and an energy storage electromotive force is generated at both ends of the energy storage element 312. At this time, the voltage detector 333 will detect the voltage value of the energy storage electromotive force, which is lower than that of the AC power source 35. When the user releases the button of the spring switch 311, the spring switch 311 will return to be a short circuit, and at this time the voltage value detected by the voltage detector 333 is just the voltage value of the AC power source 35. The voltage detector 333 sends a signal to the signal controller 332, when detecting a voltage drop due to the converting from the AC power source 35 to the energy storage electromotive force or a voltage rise due to the converting from the energy storage electromotive force to the AC power source 35.

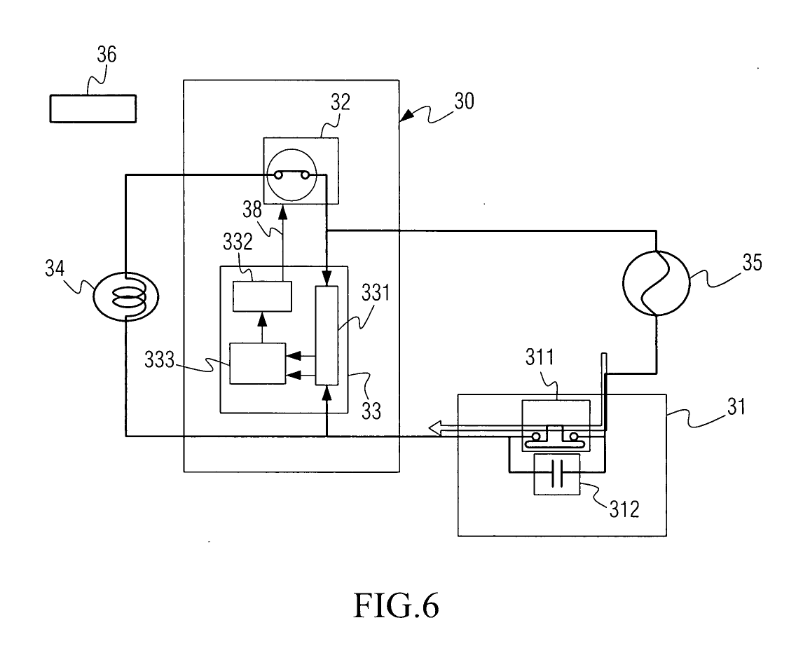

As shown in FIG. 6, the voltage detector 333 sends a signal to the signal controller 332, which will control the power switch module 32 into a short circuit through a control circuit 38, when detecting a change of voltage due to the converting between the AC power source 35 and the energy storage electromotive force, so as to conduct the current, thus the electrical device 34 turns on. However, if the power switch module 32 is preset to be a short circuit, the signal controller 332 will control the power switch module 32 into an open circuit so as to cut off the current, thus the electrical device 34 turns off.

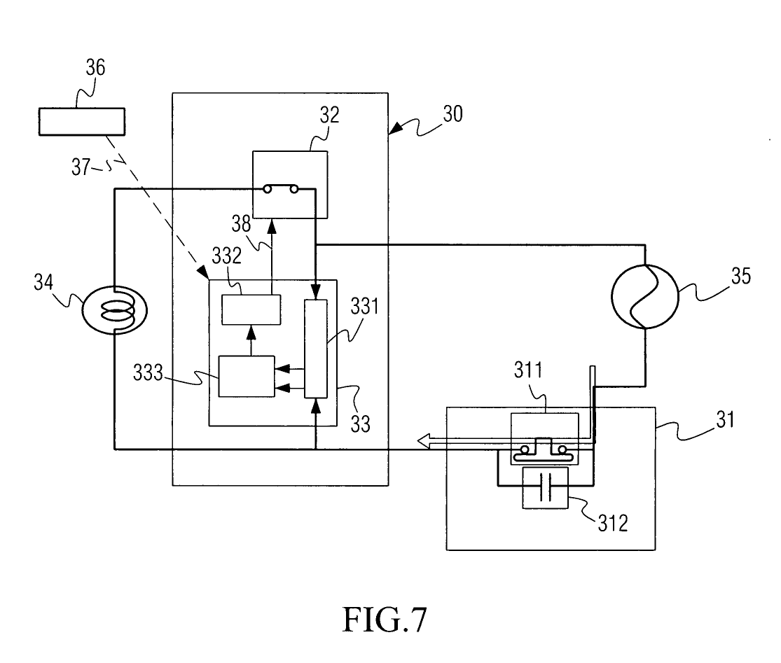

As shown in FIG. 7, the user transmits a wireless signal 37 by a signal transmitter 36 when the spring switch 311 is a short circuit. The wireless signal 37 is received by the signal controller 332 to control the power switch module 32 to be a short or open circuits so as to turn on/off the electrical device 34.

The feature of the present invention is that, a user can press an uninterruptible voltage regulating switch in a local manual control manner by using an electronic switching device, or in a remote control manner, by transmitting a wireless signal through a signal transmitter so as to control the on/off of any electrical device.

Moreover, locations of the elements in the electronic switching device can be varied to be compatible with any circuit-wiring style in a building. Therefore, the electronic switching device is particularly suitable for electrical devices, such as, lamp devices, air conditioners, power door locking devices, or ceiling fans, etc.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An uninterruptible voltage regulating switch, connected to an external alternating current (AC) power source, comprising:
a spring switch with a button, wherein the spring switch is a short circuit normally and turns into an open circuit once the button is pressed and hold; and
an energy storage element, connected to the spring switch in parallel, wherein a current flows through a branch circuit with the energy storage element when the spring switch is an open circuit, and thus an energy storage electromotive force is generated at both ends of the energy storage element.

2. The uninterruptible voltage regulating switch according to claim 1, wherein a voltage of the energy storage electromotive force is lower than that of the external AC power source.

3. The uninterruptible voltage regulating switch according to claim 1, wherein the energy storage element is a capacitor.

4. An electronic switching device using an uninterruptible voltage regulating switch externally connected to an AC power source, for controlling the turning on/off of any electrical device, comprising:
an uninterruptible voltage regulating switch, having a spring switch with a button, wherein the spring switch is a short circuit normally, being an open circuit when the button is pressed and hold; and an energy storage element, connected in parallel to the spring switch, wherein when the spring switch is an open circuit, a current will flow through a branch circuit with the energy storage element, and an energy storage electromotive force is generated at both ends of the energy storage element; and
a remote control module, connected to the electrical device, having a power switch module for supplying or cutting off the power for the electrical device; a signal controller for controlling the power switch module through a control circuit after receiving a control signal; and a voltage detector, capable of detecting a voltage difference due to the converting between the external power source and the energy storage electromotive force, and sending a signal to the signal controller.

5. The electronic switching device according to claim 4, wherein the electronic switching device further comprises a signal transmitter for transmitting a wireless signal when the voltage regulating switch is a short circuit, and the wireless signal is received by the signal controller, thus actuating the power switch module.

6. The electronic switching device according to claim 4, wherein the power switch module includes a silicon-controlled rectifier (SCR), a TRAIC, or a RELAY.

7. The electronic switching device according to claim 4, wherein the remote control module further comprises a voltage stabilizer.

8. The electronic switching device according to claim 4, wherein the electrical device includes a lamp device, an air conditioner, a power door locking device, or a ceiling fan.
